(19) United States
(12) Patent Application Publication
(10) Pub. No.: US 2008/0235450 A1
(43) Pub. Date: Sep. 25, 2008

(54) Updating Entries Cached by a Network Processor

(76) Inventors: Yongxiang Han, Beijing (CN); Yu Zhang, Beijing (CN); Zhihong Yu, Beijing (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/586,800

(22) PCT Filed: Sep. 28, 2005
(86) PCT No.: PCT/CN2005/001594

§ 371 Date: Jul. 19, 2006

(51) Int. Cl. G06F 12/00

(52) U.S. Cl. 711/118; 711/E12.001

(57) ABSTRACT

Machine-readable media, methods, and apparatus are described to update network processor cache entries in corresponding local memories and update cached entries based upon information stored in corresponding buffers for the microengines. A control plane of the network processor identifies each microengine having updated entry stored in corresponding local memory, and store information in the corresponding buffer for each identified microengine to indicate that the entry has been updated in the external memory.

### BACKGROUND

A network communication system transmits information in packets from a transmitter to a receiver through one or more routers which route the packets between nodes within a network or between networks. The router may comprise one or more network processors to process and forward the packets to different destinations, and one or more external memories to store entries used by the network processors, such as node configuration data, packet queue and flow configuration data, etc.

The network processor may comprise a control plane to setup, configure and update the entries in the external memories, and a data plane having a plurality of microengines to process and forward the packets by utilizing the entries. Each of the microengines may have a local memory to store entries of the external memories that are frequently used. Once the control plane updates entries in the external memory, it may send a signal to the microengine(s) of the data plane that may cache or store the updated entries in its local memory. In response to the signal, the microengine(s) may flush all entries stored in the local memory to make them consistent with entries stored in the external memory.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 shows an embodiment of a network device.

FIG. 2 shows an embodiment of a network processor of the network device of FIG. 1.

FIG. 3 shows an embodiment of a method implemented by a control plane of the network processor depicted in FIG. 2.

FIG. 4 shows an embodiment of another method implemented by a microengine of the network processor depicted in FIG. 2.

FIG. 5 shows a data flow diagram of an embodiment for updating entries cached by the network processor depicted in FIG. 2.

### DETAILED DESCRIPTION

The following description describes techniques for updating entries cached in a network processor. In the following description, numerous specific details such as logic implementations, pseudo-code, means to specify operands, resource partitioning/sharing/duplication implementations, types and interrelationships of system components, and logic partitioning/integration choices are set forth in order to provide a more thorough understanding of the current invention. However, the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, that may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.) and others.

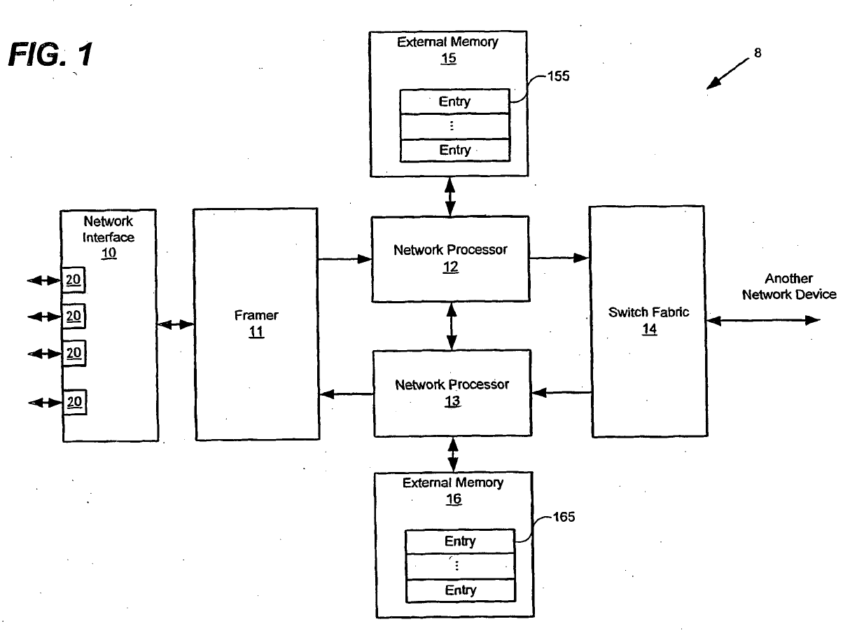

An embodiment of a network device 8 to route packets of a network communication system is shown in FIG. 1. The network device 8 may comprise a network interface 10, a framer 11, one or more network processors 12/13, a switch fabric 14, and one or more external memories 15/16. Examples for the network device 8 may comprise an ATM switch (Asynchronous Transfer Mode), an IP router (Internet Protocol), a SDH DXC (Synchronous Digital Hierarchy Data-cross Connection), and the like.

The framer 11 may perform operations on frames. In an embodiment, the framer 11 may receive a line datagram from a network interface 10 of the network communication system, delimitate frames and extract payload, such as Ethernet packet from the frames. In another embodiment, the framer 11 may receive packets from network processor 13, encapsulate the packets into frames and map the frames onto the network interface 10. The framer 11 may further perform operations such as error detection and/or correction. Examples for the framer 11 may comprise a POS (packet over Synchronous Optic Network) framer, a High-Level Data Link (HDLC) framer or the like.

The network processors 12 and 13 may perform operations on packets. In an embodiment, the network processor 12 may process and forward the packets from the framer 11 to an appropriate port of another network device through the switch fabric 14. For example, the network processor 12 may assemble IPv4 (Internet Protocol version 4) packets into CSIX (Common Switch Interface Specification) packets, modify packet headers and payloads, determine appropriate ports and forward the CSIX packets to the appropriate ports of the another network device. The network processor 13 may process and forward packets from the switch fabric 14 to appropriate ports 20 of the network interface 10 through the framer 11. For example, the network processor 13 may reassemble CSIX packets into IPv4 packets, modify packet headers and payloads, determine appropriate ports 20 and forward the IPv4 datagrams to the appropriate ports 20. Examples for the network processors 12 and 13 may comprise Intel® IXP 2XXX (e.g., IXP2400, IXP2800) network processors.

The switch fabric 14 may receive and send packets from/to a network processor connected therewith. Examples for the switch fabric 14 may comprise a switch fabric conforming to CSIX or other fabric technologies such as HyperTransport, Infiniband, PCI-X, Packet-Over-Synchronous Optical Network, RapidIO, and Utopia.

The external memories 15 and 16 may store entries 155/165 used by the network processors 12 and 13 to process and forward the packets. The entries may comprise node configuration data, queue configuration data, flow configuration data, network routing data, etc. The external memories 15 and 16 may further buffer the packets. In one embodiment, the external memory 15/16 may comprise SDRAM (Synchronous Dynamic Random Access memory) to store packets and QDR SRAM (Quad Data Rate Static Random Access Memory) to store entries.

Other embodiments may implement other modifications and variations on the structure of the network device as depicted in FIG. 1. For instance, the network processors 12 and 13 may perform framing duties instead of the framer 11 and the switch fabric may be omitted in a single-box scenario. For another instance, the network processors 12 and 13 may be integrated as one.

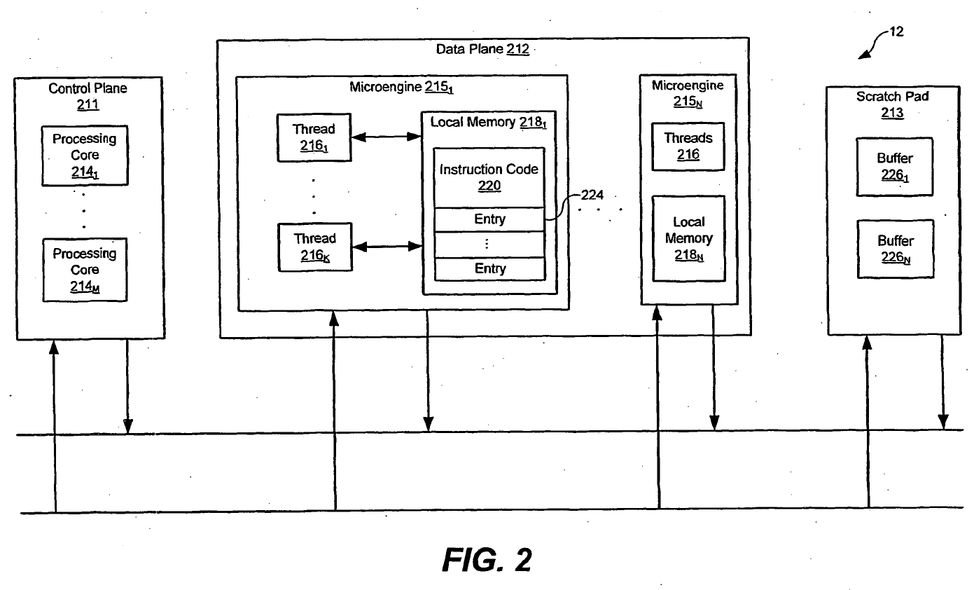

An embodiment of the network processor 12 (or network processor 13) is shown in FIG. 2. As shown, the network processor 12 may comprise a control plane 211, a data plane 212 and a scratch pad 213 that are communicable with each other through a bus connection.

The control plane 211 may be implemented as an integrated circuit (IC) with one or more processing cores 214₁ . . . 214_{M} such Intel® XScale® processing cores or StrongARM® processing cores to execute instructions to perform various tasks. In an embodiment, the processing cores 214₁ . . . 214_{M} of the control plane 211 may execute instructions to setup, configure and update entries 155/165 stored in the external memories 16116. For instance, the processing cores 214₁ . . . 214_{M} may update the external memories 15/16 which contain entries such as, for example, configuration data for nodes, configuration data for each packet queue, configuration data for each packet flow, etc. In another embodiment, the processing cores 214₁ . . . 214_{M} may further handle packets containing protocol message and routing information that may need relatively complex computations. For instance, the processing cores 214₁ . . . 214_{M} may process routing protocol packets containing routing information such as, for example, RIP (Routing Information Protocol) packets, OSPF (Open Shortest Path First) packets, and the like.

The data plane 212 may comprise a plurality of microengines 215₁ . . . 215_{N} in FIG. 2 that may be communicable with each other. Each of the microengines may comprise a plurality of threads 216₁ . . . 216_{K} to process and forward packets and one or more local memories 218₁ . . . 218_{N} to store instruction code 220 and entries 224. The local memory 218₁ . . . 218_{N} may comprise a control store, a memory, general purpose registers, transfer registers, and/or other storage mechanisms. In an embodiment, the local memories 218₁ . . . 218_{N} may comprise instruction code 220 executable by the threads 216₁ . . . 216_{K} and one or more entries 224 consistent with the entries 155/165 of the external memories 15/16. The threads 216₁ . . . 216_{K} may access the local memories 218₁ . . . 218_{N} to fetch some useful information for packet forwarding. Entries 155/165 may be cached from the external memory 15/16 to the local memories 218₁ . . . 218_{N} of the microengines 215₁ . . . 215_{N} based upon some criteria, for example, whether the entries 155/165 are frequently used by one or more microengines 215₁ . . . 215_{N} of the data plane 212. Further, the entries 155/165 cached by one microengine 215₁ . . . 215_{N} may be different from the entries 155/165 cached by another microengine 215₁ . . . 215_{N}.

The scratch pad 213 is accessible by both the processing cores 214₁ . . . 214_{M} of the control plane 211 and the microengines 215₁ . . . 215_{N} of the data plane 212. The scratch pad 213 may comprise a buffer 226₁ . . . 226_{N} to store data for each microengines 215₁ . . . 215_{N}. The buffers 226₁ . . . 226_{N} may be implemented using various structures such as, for example, ring buffers, link lists, stacks, etc. In other embodiments, the scratch pad 215 may be regarded as a flat memory.

In an embodiment, processing cores 214₁ . . . 214_{M} of the control plane 211 may update one or more entries 155/165 in the external memories 15/16 by adding, deleting or changing one or more entries 155/165, and may write information related to the updated entries 155/165 to each buffer 226₁ . . . 226_{N} of the scratch pad 213 associated with a microengine 215₁ . . . 251_{N} that stores the updated entries 155/165 in its local memory 218₁ . . . 218_{N}. Then, the microengines 215₁ . . . 215_{N} may extract information from its buffer 226₁ . . . 226_{N}, read the updated entries 155/165 from the external memories 15/16 and update the corresponding entries 224 in the local memories 218₁ . . . 218_{N}. The information written in the buffers 226₁ . . . 226_{N} may comprise entry identifiers (e.g. addresses, entry numbers, entry pointers) that uniquely identify entries 155/165 of the external memories 15/16.

Other embodiments may implement other modifications and variations on the structure of the network processor as depicted in FIG. 2. For example, the network processor 12 may further comprise a hash engine, a peripheral component interconnect (PCI) bus interface for communicating, etc.

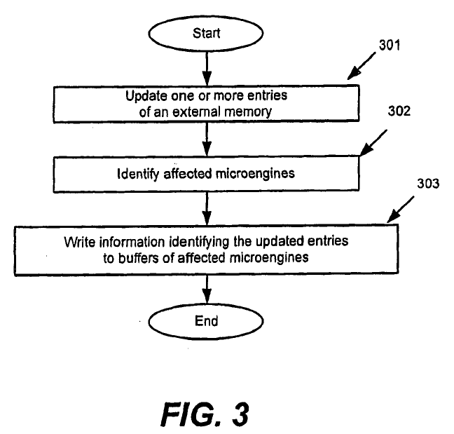

FIG. 3 shows a process implemented by one or more processing cores 214₁ . . . 214_{M} of the control plane 211 to update an external entry 155/165 stored in an external memory 15/16. As shown, in block 301, the control plane 211 may update an entry 155 in the external memory 15. Then, in block 302, the control plane 211 may search for microengine(s) 215₁ . . . 215_{N} of the data plane 212 affected by the updated entry 155. In one embodiment, the control plane 211 determines a microengine 215₁ . . . 215_{N} is affected by the updated entry 155 by determining that the microengine 215₁ . . . 215_{N} has the updated entry 155 cached in its corresponding local memory 218₁ . . . 218_{N}.

The control plane 211 may implement block 302 in various ways. In an embodiment, the control plane 211 may determine the affected microengines 215₁ . . . 215_{N} by referring to a table of the external memory 15/16 or scratch pad 213 that lists the microengines 215₁ . . . 215_{N} having cached a particular external entry 155. For example, the control plane 211 may supply a CAM (content addressable memory) of the external memory 15 with an identifier (e.g. an address, index, hash value, etc.) for the updated entry 155 to obtain a list of microengines 215₁ . . . 215_{N} that have the entry 155 cached. In particular, the CAM may return a data word having at least N bits wherein each bit indicates whether a corresponding microengine 215₁ . . . 215_{N} has the updated entry 155 cached. However, it should be appreciated that the control plane 211 may utilize other techniques and structures to maintain a corresponds between entries 155/165 and the microengines 215₁ . . . 215_{N} that have stored local copies of the entries 155/165.

In block 303, the control plane 211 may write information associated with the external entry 155 updated in block 301 to buffers 226₁ . . . 226_{N} of microengines 215₁ . . . 215_{N} affected by the updated entry 155. The information may comprise identifiers that identify external entry 155/165 that have been updated by the control plane 211.

For instance, if an entry 155 of external table 151 is updated in block 301, the control plane 211 may search for the microengines 215₁ . . . 215_{N}. that store the entry 155 in their local memories 218₁ . . . 218_{N} (block 302). Then, the control plane 211 in block 303 may write an identifier (e.g. address, entry number, entry pointer, and/or other data) for the updated entry 155 to the buffers 226₁ . . . 226_{N} of the affected microengines 215₁ . . . 215_{N} identified in block 302. For example, if the control plane 211 determines in block 302 that microengines 215₁ and 215_{N} have cached the updated entry 155, then the control plane 211 in block 303 may write an identifier for the entry 155 to the corresponding buffers 226₁ and 226_{N} to inform the microengines 215₁ and 215_{N} that the identified entry 155 has been updated.

In another embodiment, if all entries or more than a threshold level of entries of the external memory 15 are updated in block 301, the control plane 211 may forgo block 302 and write a wildcard identifier to the buffers 226₁ . . . 226_{N} indicating all cached entries 155 of the external memory 15 are invalid or outdated.

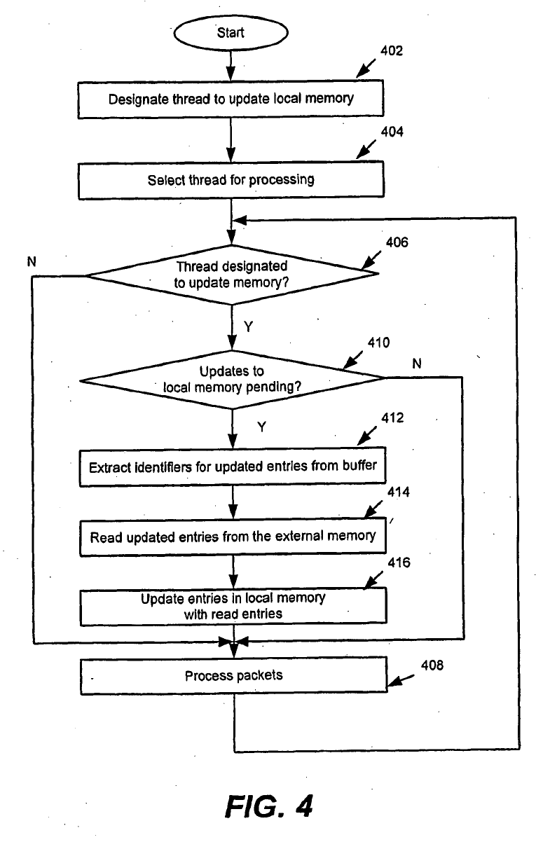

FIG. 4 shows an embodiment of a method to update one ore more entries 224 of local memories 218₁ . . . 218_{N} of the data plane microengines 215₁ . . . 215_{N}. In block 402, one thread 216₁ . . . 216_{K} of each microengine 215₁ . . . 215_{N} of the data plane 212 may be designated or otherwise configured to perform the task of updating cached entries 224 of the microengine 215₁ . . . 215_{N}. In one embodiment, the control plane 211 may designate a thread 216₁ . . . 216_{K} of each microengine 215₁ . . . 215_{N} that is to update the cached entries 224 of the microengine 215₁ . . . 215_{N}. Other embodiments may utilize other techniques to designate the thread to update the cached entries 224. For example, the microengine 215₁ . . . 215_{N} may designate the thread, the thread may be predetermined by the instruction code 220, and/or the thread designation may be hardwired into the microengine 215₁ . . . 215_{N}. In block 404, a thread 216₁ . . . 216_{K} of a microengine 215₁ . . . 215_{N} may be selected to continue executing its assigned tasks. To this end, the microengine 215₁ . . . 215_{N} and/or the control plane 211 may awaken and/or otherwise activate the selected thread using various thread scheduling algorithms such as, for example, round robin, priority, weighted priority, and/or other scheduling algorithms.

In block 406, the selected thread 216₁ . . . 216_{K} may determine whether the selected thread 216₁ . . . 216_{K} is designated to update the local memory 218₁ . . . 218_{N} of its microengine 215₁ . . . 215_{N}. If selected thread 216₁ . . . 216_{K} determines in block 406 that another thread 216₁ . . . 216_{K} is designated for updates, then the selected thread 216₁ . . . 216_{K} in block 408 may continue to process packets in a normal fashion. If, however, the selected thread 216₁ . . . 216_{K} is designated to update its local memory 218₁ . .. 218_{N}, then the thread 216₁ . . . 216_{K} in block 410 may determine whether the buffer 226₁ . . . 226_{K} for its microengine 215₁ . . . 215_{N} indicates that entries 226 are invalid or outdated.

The selected thread 216₁ . . . 216_{K} may implement block 410 in various ways. For an embodiment wherein the buffers 226₁ . . . 226_{N} are scratch rings, the selected thread 216₁ . . . 216_{K} may execute a predetermined instruction (e.g. ‘br_linp_state[ . . . ]’) of the instruction code 220 and may determine whether a returned value of the predetermined instruction is true (‘1’) or false (‘0’). The selected thread 216₁ . . . 216_{K} may determine no updates are pending if the returned value is false, and likewise may determine one or more entries 226 of its local memory 218₁ . . . 218_{N} are to be updated if the returned value is true,

If the selected thread 216₁ . . . 216_{K} determines to update entries 224 of its local memory 218₁ . . . 218_{N}, the thread 216₁ . . . 216_{K} in block 412 may extract identifiers for the updated entries 155/165 from the buffer 226₁ . . . 226_{N} associated with the microengine 215₁ . . . 215_{N} of the thread 216₁ . . . 216_{K}. The information may comprise an entry identifier that uniquely identifies the updated entries 155/165 of the external memories 15/16. Such an identifier may comprise an external memory number, an external memory pointer, an entry number, an entry pointer, and/or other identifying information from which an entry 155/165 may be discerned. However, if the selected thread 216₁ . . . 216_{K} determines to update no entries 224 of its local memory 218₁ . . . 218_{N}, the selected thread 216₁ . . . 216_{K} may continue to block 408 to perform normal packet processing.

In block 414, the selected thread 216₁ . . . 216_{K} may read entries 155/165 from the external memory 15/16 that have been identified by information in its corresponding buffer 226₁ . . . 226_{N} as being updated. Further, the selected thread 216₁ . . . 216_{K} may update corresponding cached entries 224 based upon the entries read from the external memory 15/16 (block 416).

Other embodiments may implement other modifications and variations to the process as depicted in FIG. 4. For example, a microengine 215₁ . . . 215_{N} may not assign a single thread 216₁ . . . 216_{K} to perform the task of updating local memory 218₁ . . . 218_{N}. Instead, each thread 216₁ . . . 216_{K} of the microengine 215₁ . . . 215_{N} may determine whether to update entries 224 cached in its local memory 218₁ . . . 218_{N} before continuing with normal packet processing.

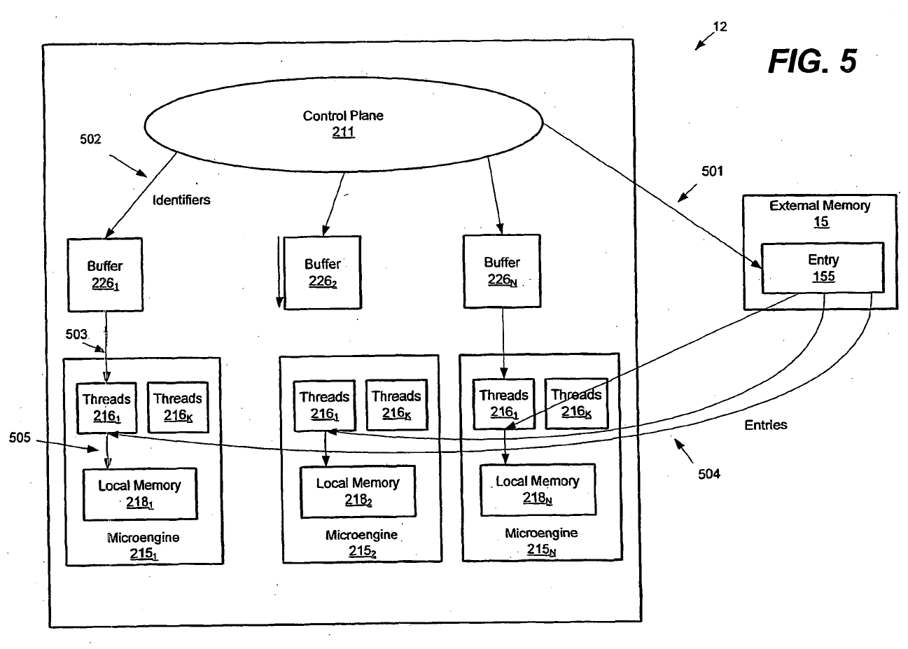

A data flow diagram illustrating an embodiment of updating entries 224 of local memories 218₁ . . . 218_{N} of the network processor 12 is shown in FIG. 5. As shown, the control plane 211 may update one or more external entries 155 in an external memory 15 (arrow 501). Then, the control plane 211 may write information associated with the updated external entries 155 to the buffers 226₁ . . . 226_{N} assigned to the affected microengines 215₁ . . . 215_{N} (arrow 502). In response to a thread 216₁ . . . 216_{K} determining, based upon information stored in its buffers 218₁ . . . 218_{N}, that one or more cached entries 224 of its microengine 215₁ . . . 215_{N} have been updated, the thread 216₁ . . . 216_{K} may read the updated external entries 155 from the external memory 15 (arrow 504) and update the corresponding local memory 218₁ . . . 218_{N} with the read entries 155 (arrow 505).

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method of a network processor comprising a plurality of microengines that process network packets, the method comprising
updating an entry in a memory external to the network processor;.
identifying a microengine of the plurality of microengines that has stored the entry in a local memory for the microengine; and
writing information to a buffer for the identified microengine that indicates the entry has been updated.

2. The method of claim 1 further comprising updating the entry in the local memory for the microengine in response to determining, based upon the information written to the buffer, that the entry has been updated.

3. The method of claim 1 further comprising
reading the entry from the memory external to the network processor in response to determining, based upon the information written to the buffer, that the entry has been updated; and
updating the local memory for the microengine based upon the entry read from the memory external to the network processor.

4. The method of claim 1 further comprising
updating the entry in the local memory for the microengine in response to determining, based upon the information written to the buffer, that the entry has been updated; and
processing a network packet based upon the entry updated in the local memory for the microengine.

5. The method of claim 1 further comprising designating at least one thread of each microengine of the plurality of microengines to update entries of a corresponding local memory for each microengine based upon information stored in a corresponding buffer for each microengine.

6. The method of claim 1 further comprising activating a thread of the microengine to process information stored in the buffer and to update the local memory of the microengine based upon the information stored in the buffer.

7. The method of claim 1 further comprising determining that all entries in the local memory for the microengine are invalid based upon the information stored in the buffer for the microengine.

8. The method of claim 1 further comprising determining that all entries. In the local memory for the microengine are outdated based upon the information stored in the buffer for the microengine.

9. A network processor to process network packets based upon entries stored in an external memory, comprising:
a plurality of microengines to process network packets, each microengine having a corresponding local memory to cache entries stored in the external memory and a corresponding buffer to identify entries in the local memory updated in the external memory, and
a control plane to update an entry in the external memory, to identify each microengine of the plurality of microengines having the entry stored in the corresponding local memory, and to store an identifier for the entry in the corresponding buffer for each identified microengine to indicate that the entry has been updated in the external memory.

10. The network processor of claim 9 wherein the control plane comprises at least one processing core to update the entry, to identify each microengine, and to store the identifier in the corresponding buffer for each identified microengine.

11. The network processor of claim 9 wherein each microengine
reads the entry from the external memory in response to determining, based upon the identifier written to the corresponding buffer, that the entry has been updated, and
updates the corresponding local memory based upon the entry read from the external memory.

12. The network processor of claim 9 wherein each microengine
updates the entry in the corresponding local memory in response to determining, based upon the identifier written to the corresponding buffer, that the entry has been updated, and
processes a network packet based upon the entry updated in the corresponding local memory.

13. The network processor of claim 9 wherein each microengine comprises a plurality of threads to process network packets and at least one thread to update entries of the corresponding local memory upon identifiers for entries stored in the corresponding buffer.

14. A network device, comprising:
a plurality of ports to transfer network packets;
a memory to store entries used to process network packets;
a network processor to process network packets based upon the entries stored in the memory external to the network processor, wherein the network processor comprises
a plurality of microengines to process network packets, each microengine having a corresponding local memory to cache entries stored in the external memory and a corresponding buffer to identify entries in the local memory updated in the external memory, and
at least one processing core to control the plurality of microengines, to update entries in the memory external to the network processor, to identify each microengine of the plurality of microengines having updated entries of the memory stored in corresponding local memory, and to store information in the corresponding buffer for each identified microengine to indicate updated entries of the memory.

15. The network device of claim 14 wherein each microengine
reads updated entries from the memory based upon the information in the corresponding buffer, and
updates the corresponding local memory based upon the updated entries read from the memory.

16. The network device of claim 14 wherein each microengine
updates entries in the corresponding local memory based upon information in their corresponding buffer, and
processes network packets based upon the entries updated in the corresponding local memory.

17. The network device of claim 14 wherein each microengine comprises a plurality of threads to process network packets, wherein at least one thread of the plurality of threads updates entries of the corresponding local memory based upon information in the corresponding buffer.

18. The network device of claim 14 wherein
each microengine comprises a plurality of threads to process network packets, and
the at least one processing core designates at least one thread of each microengine to update entries of the corresponding local memory of the microengine based upon information in the corresponding buffer of the microengine.

19. A machine readable medium comprising a plurality of instructions that in response to being executed result in a network device
updating an entry in a memory external to a network processor of the network device;
identifying each microengine of the network processor that has cached the entry in a local memory of the network processor;
storing information to a corresponding buffer for each identified microengine, the information indicating the entry has been updated in the memory external to the network processor; and
updating the entry cached in the local memory based upon the information in the corresponding buffer for each identified microengine.

20. The machine readable medium of claim 19 wherein the plurality of instructions further result in the network device
reading the entry from the memory external to the network processor in response to determining, based upon the information written to the buffer, that the entry has been updated; and
updating the entry cached.in the local memory based upon the entry read from the memory external to the network processor.

21. The machine readable medium of claim 19 wherein the plurality of instructions further result in the network device processing a network packet based upon the updated entry cached in the local memory.

22. The machine readable medium of claim 19 wherein the plurality of instructions further result in the network device designating at least one thread of each microengine of the plurality of microengines to update entries of the local memory based upon information stored in the corresponding buffer for each microengine.
